(19) United States
(12) Patent Application Publication
(10) Pub. No.: US 2023/0206886 A1
(43) Pub. Date: Jun. 29, 2023

(54) "Clippy Pic"

(71) Applicant: Roxanne Kelly, Honolulu, HI (US)

(72) Inventor: Roxanne Kelly, Honolulu, HI (US)

(21) Appl. No.: 18/069,948

(22) Filed: Dec. 21, 2022

Related U.S. Application Data
(60) Provisional application No. 63/361,410, filed on Dec. 21, 2021.

(51) Int. Cl. G10D 3/173

(52) U.S. Cl. CPC G10D 3/173

(57) ABSTRACT

The “Clippy Pic” is a usable, wearable guitar pic.

There is a clip, any type of clip that can fit through the hole drilled in the guitar pic.

One side of the clip is attached to earrings, necklace, bracelet, anklet, zipper, gig bag, key chain, etc.

The clip part is attached through the hole in the guitar pic and easily removed at any time to play guitar.

### BACKGROUND

I had been putting holes in the decorative guitar pics and making earrings out of them. I was playing guitar ith some friends, and someone needed a pic.

I said, “too bad I couldn't just take them off my earrings.” Then I thought what a cool idea and my mom said, “you should patent that” and so began the process.

### SUMMARY

I started with earrings and ordered smallclips. Then I started making necklaces, bracelets, anklets, zippers, gig bags, etc. All with guitar pics clipped to the items and removed when ready to play guitar or any instrument a pic may be used for.

I did the research and found that no one thought about a wearable, removable usable guitar pic. They make jewelry with pics and pic cases that hang on jewelry but none that are removable and usable attached directly to the item. The response from music lovers made it evident that this was a good idea.

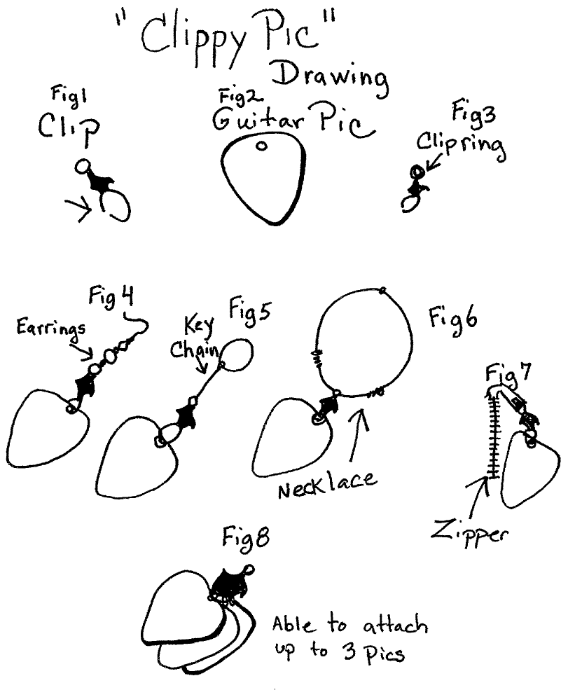

The “Clippy Pic” can be any type of clip (FIG. 1) that can be attached directly through the top or bottom of the guitar pic. (FIG. 2)

You then attach the clip ring (FIG. 3) to the earrings (FIG. 4),

Key chain (FIG. 5), necklace (FIG. 6), zipper (FIG. 7), etc.

You can also dip up to 1,2 or 3 guitar pics at a time (FIG. 8).

The “Clippy Pic” is desirable, affordable, and needed.

Any band member of any group along with girlfriends, fans, groupies, and just all musicians in general would love these. They can put their band names, logos, personal pictures, sayings, or just about anything for promotions or advertising.

Anywhere or anytime, you go to where people are playing music there is always someone who needs a pic. They usually have them in their pocket, wallet or guitar case, or pic case, and a lot of times they forget or end up playing on the fly and need one. So, you have them clipped to your earrings, key chains, necklace, zipper and you are never without!

The “Clippy Pic” will now be a musician's best friend!!!!!!

Claims

I claim that by attaching a guitar pic to a clip and wearing it on a piece of clothing, jewelry, key chain, zipper, etc: Makes this invention unique by having a pic handy at anytime one wants to play a stringed instrument. I claim that I, being a musician, have never seen one and know how desirable this idea can be. Musicians putting their band on them and making them custom would be a very lucrative idea.
